(19) United States
(12) Patent Application Publication
(10) Pub. No.: US 2018/0088412 A1
(43) Pub. Date: Mar. 29, 2018

(54) DISPLAY DEVICE

(71) Applicant: SAMSUNG ELECTRONICS CO., LTD., Suwon-si (KR)

(72) Inventors: Ki Hyung KANG, Suwon-si (KR); Sang Hyun SOHN, Suwon-si (KR); Kyung Soo PARK, Yongin-si (KR)

(73) Assignee: SAMSUNG ELECTRONICS CO., LTD., Suwon-si (KR)

(21) Appl. No.: 15/698,206

(22) Filed: Sep. 7, 2017

(30) Foreign Application Priority Data
Sep. 27, 2016 (KR) 10-2016-0123948

(51) Int. Cl. G02F 1/1335

(52) U.S. Cl. CPC G02F 1/133555; G02F 2001/133507

(57) ABSTRACT

A reflective display device is provided. The reflective display device includes a reflective display panel, a light unit configured to emit light to the reflective display panel, and a refractive sheet disposed on a front surface of the reflective display panel and configured to refract the light emitted from the light unit toward the reflective display panel.

### CROSS-REFERENCE TO RELATED APPLICATIONS

This application claims priority from Korean Patent Application No. 10-2016-0123948, filed on Sep. 27, 2016 in the Korean Intellectual Property Office, the disclosure of which is incorporated herein by reference in its entirety.

### BACKGROUND

### 1. Field

Methods and apparatuses consistent with exemplary embodiments relate to a display device, and more particularly, to a display device including a reflective display panel that does not use a backlight unit.

### 2. Related Art

A display device is an output device that converts and visually displays electrical information. Display devices are used in various portable terminal devices such as smart phones, tablet PCs, and the like, as well as televisions and monitor devices.

Multiple types of display devices are capable of outputting an image using different types of technology. For example, the display devices may include a cathode ray tube, a light emitting diode, an organic light emitting diode, an active-matrix organic light emitting diode, a liquid crystal display, an electronic paper display, or the like.

Display devices using a backlight type liquid crystal display, in which a backlight unit provides light to the back side of a transmissive display panel to display an image, are widely used. That is, a transmissive display devices are widely used. However, low-power displays are desired in various fields such as electronic books, mobile displays, and outdoor displays, reflective display devices, which use ambient light instead of a backlight are being developed.

### SUMMARY

Exemplary embodiments may address at least the above problems and/or disadvantages and other disadvantages not described above. Also, exemplary embodiments are not required to overcome the disadvantages described above, and may not overcome any of the problems described above. Exemplary embodiments provide a reflective display device having improved visibility.

According to an aspect of an exemplary embodiment, there is provided a display device including: a reflective display panel; a light unit configured to emit light to the reflective display panel; and a refractive sheet disposed on a front surface of the reflective display panel and including a plurality of prisms arranged to refract the light emitted from the light unit toward the reflective display panel.

Each of the plurality of the prisms may include an incident surface to which the light emitted from the light unit is incident, and the incident surface may have an angle that is greater than or equal to 60 and less than or equal to 90 degrees with respect to the front surface of the reflective display panel.

The light emitted from the light unit may be collimated light.

The light emitted from the light unit may have incident angle that is greater than or equal to 60 degrees with respect to the front surface of the reflective display panel.

Each of the plurality of prisms may include an inclined surface configured to totally reflect the light emitted from the light unit toward the reflective display panel.

The plurality of prisms may be arranged at an interval from each other so that the light emitted from the light unit is not blocked by a neighboring prism.

Each of the plurality of prisms may include an exit surface facing the front surface of the reflective display panel, and the plurality of prisms may be arranged at an interval from each other that is larger than a width of the exit surface.

The plurality of prisms may be continuously arranged without being spaced apart from each other.

The light unit may include: a light source module including a light source and a substrate on which the light source is arranged; a parabolic mirror configured to collimate light to the reflective display panel by reflecting light from the light source module; and a mounting member configured to mount the light source module and the parabolic mirror on one side of the reflective display panel so that the light source module and the parabolic mirror are disposed in front of the front surface of the reflective display panel.

The parabolic mirror may extend by a length corresponding to a length of the one side of the reflective display panel on which the parabolic mirror is disposed.

The light source module may extend by a length corresponding to the length of the parabolic mirror along an extending direction of the parabolic mirror and may be arranged to emit light from a focal line of the parabolic mirror toward the parabolic mirror.

According to an aspect of another exemplary embodiment, there is provided a display device including a reflective display panel; a light unit configured to emit light to the reflective display panel; and a refractive sheet disposed on a front surface of the reflective display panel and including a holographic diffraction grating configured to refract the light emitted from the light unit toward the reflective display panel.

The light unit may include: a light source module including a light source and a substrate on which the light source is arranged; a parabolic mirror configured to collimate light to the reflective display panel by reflecting light from the light source module; and a mounting member configured to mount the light source module and the parabolic mirror on one side of the reflective display panel so that the light source module and the parabolic mirror are disposed in front of the front surface of the reflective display panel.

According to an aspect of another exemplary embodiment, there is provided a display device including: a liquid crystal layer; a reflective layer disposed on a rear side of the liquid crystal layer; a light unit configured to generate collimated light; and a refractive sheet disposed on a front surface of the liquid crystal layer and configured to refract the collimated light generated by the light unit toward the liquid crystal layer.

The refractive sheet may include a plurality of prisms, and each of the plurality of prisms may include an incident surface to which the collimated light generated by the light unit is incident and an inclined surface configured to totally reflect light entering through the incident surface.

The refractive sheet may include a holographic diffraction grating configured to refract the collimated light generated by the light unit toward the liquid crystal layer.

The light unit may include: a light source module including a light source and a substrate on which the light source is arranged; and a parabolic mirror reflecting light from the light source module such that light emitted from the light source module is incident on the refractive sheet at a predetermined angle.

According to an aspect of another exemplary embodiment, there is provided a reflective display device including: a reflective display panel; a refractive sheet disposed on a front surface of the reflective display panel; and a light source disposed on one edge of the display panel and configured to emit collimated light towards the refractive sheet at a predetermined angle, wherein the refractive sheet is configured to refract the collimated light towards the reflective display panel.

The refractive sheet may include a plurality of prisms arranged to refract the collimated light towards the reflective display panel.

Each of the plurality of prisms may include an incident surface to which the collimated light is incident, the incident surface having an angle greater than or equal to 60 degrees and less than or equal to 90 degrees with respect to the front surface of the reflective display panel.

Each of the plurality of prisms may include an exit surface facing the front surface of the reflective display panel, the exit surface having a predetermined width, and the plurality of prisms may be spaced apart from each other by a predetermined interval that is greater than the predetermined width.

The plurality of prisms may be continuously arranged without being spaced apart from each other.

The refractive sheet may include a holographic diffraction grating configured to refract only light, of the collimated light, which is incident to the holographic diffraction grating at the predetermined angle.

### BRIEF DESCRIPTION OF THE DRAWINGS

The above and/or other aspects will become apparent and more readily appreciated from the following description of exemplary embodiments, taken in conjunction with the accompanying drawings in which:

FIG. 1 is a front perspective view illustrating a display device according to an exemplary embodiment;

FIG. 2 is an exploded rear perspective view illustrating the display device shown in FIG. 1, according to an exemplary embodiment;

FIG. 3 is a vertical cross-sectional view of the display device shown in FIG. 1, according to an exemplary embodiment;

FIG. 4 is a partial enlarged vertical cross-sectional view of a display device according to an exemplary embodiment;

FIG. 5 is a partial enlarged view of the vertical cross-sectional view of the display device shown in FIG. 4, according to an exemplary embodiment;

FIG. 6 is a partial enlarged vertical cross-sectional view of a display device according to another exemplary embodiment; and

FIG. 7 is a partial enlarged vertical cross-sectional view of a display device according to another exemplary embodiment.

### DETAILED DESCRIPTION

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

Also, the terms used in the description are used to describe exemplary embodiments Accordingly, it should be apparent to those skilled in the art that the following description of exemplary embodiments is provided for illustration purpose only and not for the purpose of limiting the exemplary embodiments. It is to be understood that the singular forms “a,” “an,” and “the” include plural referents unless the context clearly dictates otherwise. In description, it will be understood that the terms “includes,” “comprises,” “including,” and/or “comprising,” are used to specify the presence of stated features, figures, steps, components, or combination thereof, but do not preclude the presence or addition of one or more other features, figures, steps, components, members, or combinations thereof.

It will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the principles and spirit of the present disclosure, the scope of which is defined in the claims and their equivalents. As used herein, the term “and/or” includes any and all combinations of one or more of associated listed items.

The terms “upper side,” “lower side,” “left side,” “right side,” “horizontal” and “vertical” used in the present description are defined with reference to the drawings. The shape and position of elements are not limited by these terms.

Exemplary embodiments will now be described in greater detail with reference to the accompanying drawings.

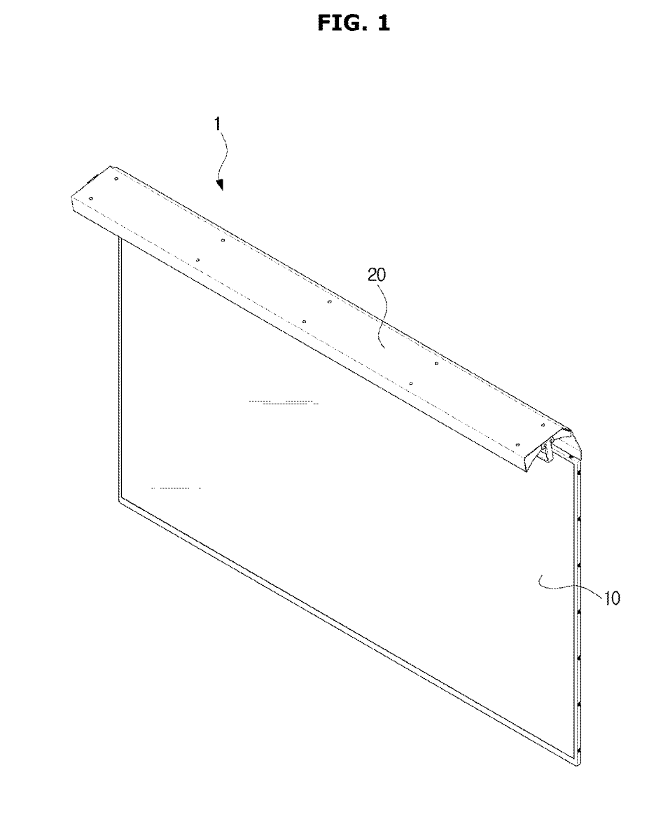

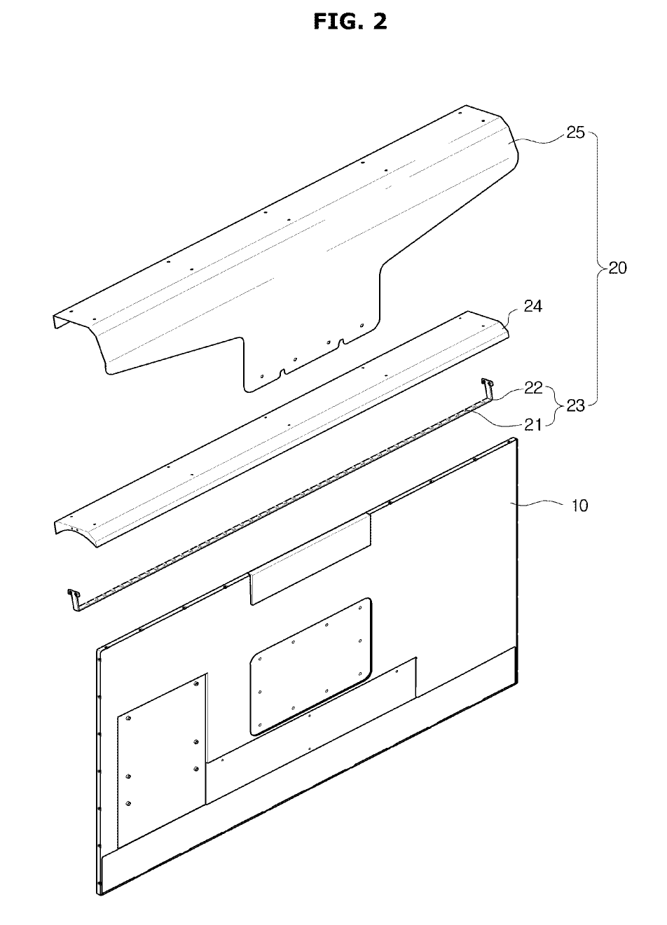

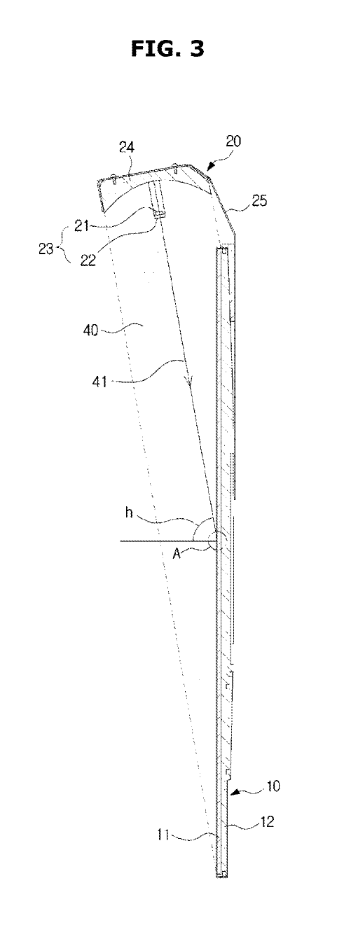

FIG. 1 is a front perspective view illustrating a display device according to an exemplary embodiment, FIG. 2 is an exploded rear perspective view illustrating the display device shown in FIG. 1, and FIG. 3 is a vertical cross-sectional view of the display device shown in FIG. 1.

In a transmissive display device, a backlight unit is disposed on the rear surface of a liquid crystal layer of a display panel, and light emitted from the light source passes through the liquid crystal layer to display an image. In contrast, the display device 1 illustrated in FIG. 1, which includes a reflective display panel 10, uses the light outside the reflective display panel 10 as a light source without a backlight unit. Specifically, a reflective display device displays an image while the incident light to the front surface of the liquid crystal layer is reflected by a reflective layer disposed on the rear side of the liquid crystal layer.

Because reflective display devices use ambient light as a light source, they consume less energy than comparative transmissive display devices and have a power efficiency advantage. However, since reflective display devices do not have a light source that emits light by itself, unlike the transmissive display devices, the brightness may be changed depending on the surrounding illumination environment. For example, when the surrounding environment is dark, such as at night, an external illumination device illuminating the reflective display device is required.

As shown in FIG. 1, the display device 1 according to an exemplary may include the reflective display panel 10 in a plate shape and a light unit 20 configured to illuminate the reflective display panel 10.

As shown in FIG. 3, the reflective display panel 10 may include a reflective display module 11 and a chassis 12 supporting the reflective display module 11. The chassis 12 may be disposed behind the reflective display module 11 and configured to support the side and rear surfaces of the reflective display module 11.

The display device 1 may further include a front cover forming a front edge and a side surface of the reflective display panel 10, and a rear cover forming a rear surface of the reflective display panel 10. The rear cover may be disposed behind the chassis 12 to face the chassis 12.

In addition, the display device 1 may include at least one printed circuit board electrically connected to the reflective display module 11. At least one printed circuit board may be mounted to the chassis 12.

The at least one printed circuit board may include a power supply board, a signal processing board, and a driving board. A circuit element for supplying power to the reflective display module 11 may be disposed on the power supply board. The signal processing board may be provided with circuit elements for receiving and processing external signals. The driving board may be provided to drive the reflective display module 11. The power supply board, the signal processing board, the driving board, and the like may be independently arranged or integrated with each other.

As shown in FIG. 2, light unit 20 may include a light source module 23 having a light source and a substrate 22 on which a light source 21 is arranged and may include a parabolic mirror 24 configured to reflect light emitted from the light source module 23 and collimate the light to the reflective display panel. The light unit 20 further includes a mounting member 25 configured to mount the light source module 23 and the parabolic mirror 24 on one side of the reflective display panel 10 such that the light source module 23 and the parabolic mirror 24 may be disposed in front of one side of the reflective display panel 10.

Referring to FIG. 1, the light unit 20 may be disposed on the front upper side of the reflective display panel 10. That is, the light source module 23 and the parabolic mirror 24 may be mounted on the upper side of the chassis 12 of the reflective display panel 10 by the mounting member 25.

The parabolic mirror 24 may extend a length corresponding to a length of one side of the reflective display panel 10 on which the parabolic mirror 24 is disposed. The parabolic mirror 24 of the light unit 20 disposed on the upper side of the reflective display panel 10 may extend the length of the upper side of the reflective display panel 10.

The light source module 23 may also extend along the extending direction of the parabolic mirror 24 by a length corresponding to the length of the parabolic mirror 24. That is, the substrate 22 is extended along the length of the parabolic mirror, and the light source 21 such as a light emitting diode (LED) may be arranged along the substrate. The light source module 23 may be disposed in the focal line of the parabolic mirror 24 and may be arranged to illuminate the light toward the parabolic mirror 24 from the focal line of the parabolic mirror 24. The light unit 20 may provide a collimated light 40 having a constant incident angle h on the entire area of the reflective display panel 10 by reflecting the light from the light source module 23 to the parabolic mirror 24.

The light unit may also be configured using an optical lens instead of a parabolic mirror. When an optical lens is used, the light source module may be disposed so that the light source faces the reflective display panel, and the optical lens may be disposed in front of the light source module such that light generated from the light source module is collimated toward the reflective display panel.

When light emitted from the light unit is not collimated light, light having a small incident angle is incident on the side of the display panel adjacent to the light unit, and light having a large incident angle is incident on the side of the display panel far from the light unit.

When light is incident on the reflective display module at a large angle, the ratio of the amount of light emitted from the front surface of the reflective display module to the amount of incident light is not large. That is, the larger the angle of incidence of the light incident on the liquid crystal layer of the display module is, the higher the reflectance of light reflected from the surface of the liquid crystal layer becomes. Therefore, the amount of light that is reflected by the reflective layer disposed on the back side of the liquid crystal layer and emerges toward the front through the liquid crystal layer is decreased as the incident angle of light incident on the liquid crystal layer of the display module becomes larger.

Therefore, when the light emitted from the light unit disposed at the upper side of the reflective display panel is not a collimated light, a displayed is bright at the upper portion of the reflective display module, but dark at the lower portion of the reflective display module.

The display device 1 according to an exemplary embodiment may include the light unit 20 configured to provide an incident light 41 having a constant angle h to the entire area of the reflective display panel 10 and a refractive sheet 50 configured to refract light emitted from the light unit 20 toward the reflective display panel 10.

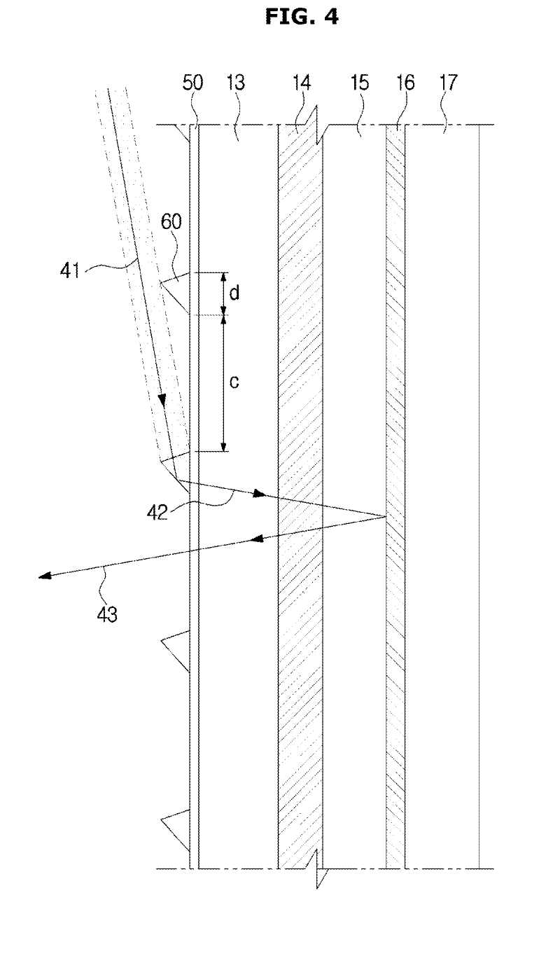

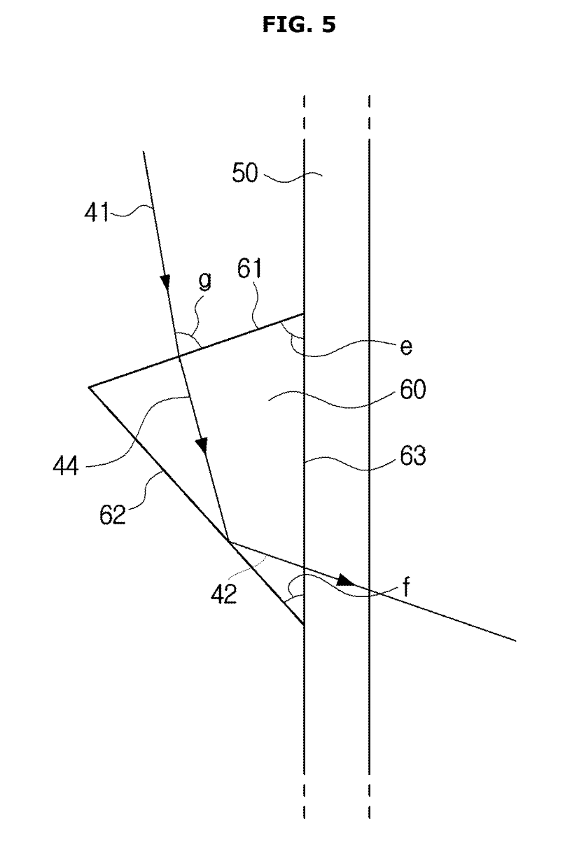

FIG. 4 is a partial enlarged vertical cross-sectional view of a display device according to an exemplary embodiment, and FIG. 5 is a partial enlarged view of the vertical cross-sectional view of the display device shown in FIG. 4, according to an exemplary embodiment.

Referring to FIGS. 4 and 5, the reflective display module 11 of the reflective display panel 10 includes an upper substrate 13 and a lower substrate 17 spaced apart from each other, a liquid crystal layer 15 arranged between the upper substrate 13 and the lower substrate 17, a reflective layer 16 disposed at the back side of the liquid crystal layer 15 and a color filter 14 disposed at the front side of the liquid crystal layer 15. The color filter 14 may be configured to selectively transmit light of a predetermined color.

The upper substrate 13 may be formed of an electrode using indium tin oxide (ITO) or the like, and a TFT (Thin Film Transistor) and a pixel electrode may be arranged on the lower substrate 17.

A refractive sheet 50 may be disposed on the front surface of the reflective display panel 10. That is, the refractive sheet 50 is disposed at the front surface side of the liquid crystal layer 15 and may be configured to refract light emitted from the light unit 20 toward the liquid crystal layer 15.

The refractive sheet 50 may include a plurality of prisms 60 configured to refract the incident light 41 emitted from the light unit 20 toward the reflective display panel 10. The plurality of prisms 60 may be arranged on the refractive sheet 50. The prisms 60 may extend along the direction in which the light source module 23 of the light unit 20 extends and may be arranged on the refractive sheet 50 in parallel with the light source module 23.

The plurality of prisms 60 may refract the incident light 41 incident from the light unit 20 at a large incident angle h toward the liquid crystal layer 15 of the reflective display panel 10. Specifically, the prism 60 may have an incident surface 61 to which the incident light 41 emitted from the light unit 20 is incident. The incident surface 61 may be provided so that the incident light 41 may be incident to the incident surface 61 at a perpendicular or almost perpendicular angle. Preferably, the incident light 41 of the light unit 20 is configured to have a large incident angle h of greater than or equal to 60 degrees and less than or equal to 90 degrees, and the incident surface 61 of the prism 60 may be formed to have an angle e of 60 degrees or more and 90 degrees or less with respect to the reflective display panel 10.

When an angle g between the incident light 41 and the incident surface 61 is large, that is, when the incident angle to the incident surface 61 of the incident light 41 is small, the light amount loss due to the reflection of the incident light 41 at the incident surface may be reduced.

The prism 60 may include an inclined surface 62 that is configured to reflect light that has passed through the incident surface 61 from the light unit 20 toward the reflective display panel 10. The prism 60 has a refractive index of 1 or more. The inclined surface 62 may totally reflect light that has entered through the incident surface 61, and an angle f between the inclined surface 62 and the reflective display panel 10 may be an angle that allows the total reflection of the light received by the prism 60. The light 42 totally reflected by the inclined surface 62 passes through an exit surface 63 of the prism 60 facing the reflective display panel 10 and may be incident to the reflective display panel 10 at a very small incident angle.

The light 42 refracted by the refractive sheet 50 and incident on the reflective display module 11 may be transmitted through the liquid crystal layer 15 and reflected by the reflective layer 16 disposed on the rear surface side of the liquid crystal layer 15. A light 43 reflected by the reflective layer 16 may again pass through the liquid crystal layer 15 and the color filter 14 to display an image on the reflective display panel 10.

The incident angle of the light 42 incident on the liquid crystal layer 15 is reduced by the refractive sheet 50 on which the plurality of prisms 60 are arranged and the reflection angle of the light 43 reflected by the reflective layer 16 is reduced, therefore the amount of light at an angle that may be viewed by the user may be increased.

The angle g between the incident light 41 incident on the incident surface 61 of the prism 60 from the light unit 20 and the incident surface 61 may be 90 degrees or less or 90 degrees or more. When the angle g between the incident light 41 and the incident surface 61 is perpendicular, the incident light 41 may be refracted while passing through the incident surface 61 of the prism 60.

Therefore, when designing the profile of the prism 60, it is possible to adjust the angle g between the incident light 41 incident on the incident surface 61 and the incident surface 61 is adjusted to determine an angle of light 44 incident on the inclined surface 62, and it is possible to adjust the angle f between the inclined surface 62 and the reflective display panel 10 according to the angle of the light incident on the inclined surface 62.

Conversely, the angle f of the inclined surface 62 and the angle of light 44 incident on the inclined surface 62 may be determined in consideration of the angle of incidence of the light 42, totally reflected from the inclined surface 62, with respect to the liquid crystal layer. The angle e of the incident surface 61 and the angle g of the incident light 41 incident on the incident surface 61 may be adjusted according to the angle of the light 44 incident on the inclined surface 62. The position of the light unit 20 and the angle of the collimated light 40 may be determined according to the angle of the incident light 41.

The plurality of prisms 60 arranged in the refractive sheet 50 may be arranged at a distance c from each other. The plurality of prisms 60 may be arranged at wider intervals than a width d of the exit surface 63. Preferably, the plurality of prisms 60 may be arranged with an interval c such that the light from the light unit 20 is not covered by the adjacent prism 60. The distance c between the prisms 60 may also be adjusted by adjusting the protruding height of the prism 60.

Since the plurality of prisms 60 arranged on the refractive sheet 50 are formed to be very small compared to the size of the reflective display panel 10, they are not directly visible to the user's eyes. However, the ambient light other than the collimated light 40 of the light unit 20 may be scattered by the prism 60. By arranging the plurality of prisms 60 at wide intervals, irregular reflection of ambient light by the prism 60 may be reduced, thereby improving visibility.

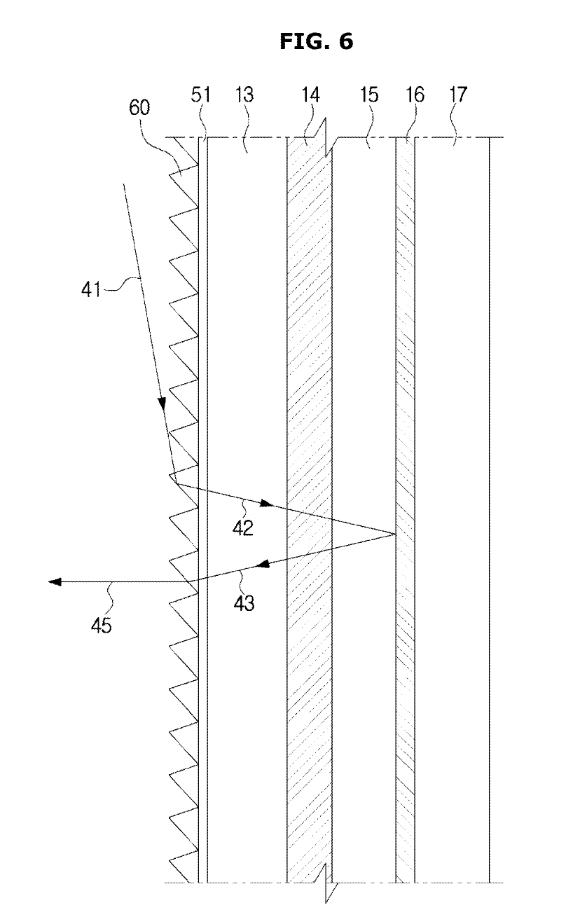

FIG. 6 is a partial enlarged vertical cross-sectional view of a display device according to another exemplary embodiment.

Referring to FIG. 6, the display device 1 may include a refractive sheet 51 having a plurality of prisms 60 arranged continuously without a gap therebetween. Other configurations are the same as those shown and described above in FIGS. 4 and 5, except that the plurality of prisms 60 are continuously arranged on the refractive sheet 51 without a gap, so a detailed description thereof will be omitted.

The refractive sheet 51 including the plurality of prisms 60 that are not spaced apart from each other may refract the light 43 having passed through the liquid crystal layer 15 and the color filter 14 after being reflected by the reflective layer. That is, the light 43 reflected by the reflective layer 16 is not reflected perpendicularly to the reflective display panel 10, unless the light 42 incident on the liquid crystal layer 15 is incident perpendicularly. However, the light 43 reflected from the reflective layer 16 may be refracted perpendicularly to the reflective display panel 10 while passing through the prism 60 provided on the refractive sheet 51.

As described above, since the plurality of prisms 60 arranged on the refractive sheet 51 are formed to be very small compared to the size of the reflective display panel 10, they are not directly visible to the user's eyes. The refractive sheet 51 in which the plurality of prisms are continuously arranged may have a large scattering of ambient light in comparison with the refractive sheet 50 in which the plurality of prisms 60 are arranged at intervals but may be provided with higher visibility to the user looking from the front of the display panel by the light 45 refracted by the prism 60 and emitted vertically.

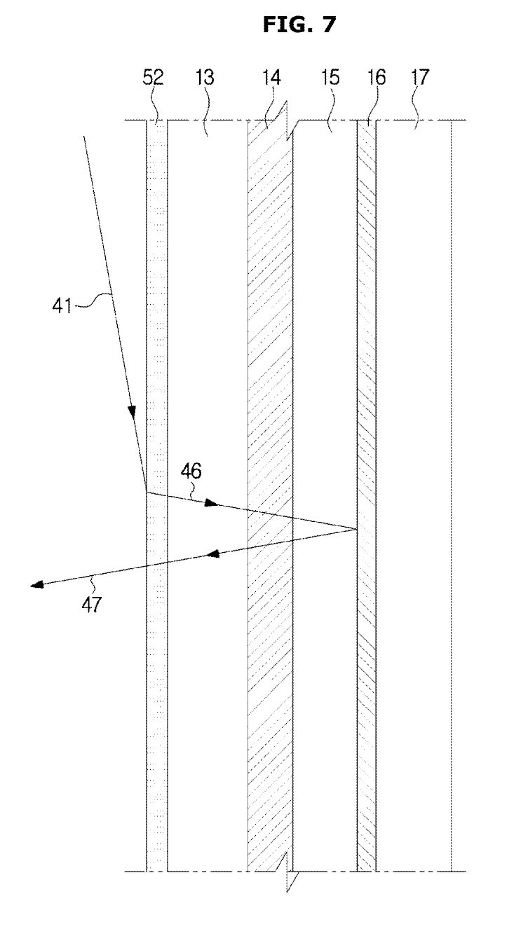

FIG. 7 is a partial enlarged vertical cross-sectional view of a display device according to another exemplary embodiment.

Referring to FIG. 7, the display device 1 may include a refractive sheet 52 disposed on the front surface of the reflective display panel 10 and having a holographic diffraction grating configured to refract light emitted from the light unit 20 toward the reflective display panel 10, i.e., toward the liquid crystal layer 15.

The refractive sheet 52 on which the holographic diffraction grating is formed may be configured to refract only the light incident at a specific angle. The incident light 41 emitted from the light unit 20 is a collimated light having a specific incident angle so that the light is refracted toward the reflective display panel 10 while passing through the refractive sheet 52 on which the holographic diffraction grating is formed. A light 46 refracted by the refractive sheet 52 is reflected by the reflective layer 16 disposed on the back surface of the liquid crystal layer 15 and then transmitted through the liquid crystal layer 15 and the color filter 14 to display an image on the reflective display panel 10.

Since the refractive sheet 52 refracts only the light incident at the angle of the incident light 41 emitted from the light unit 20, a light 47 reflected from the reflective layer 16 may pass through the refractive sheet 52 without being refracted again.

The refractive sheet 52 refracts the incident light 41 incident on the reflective display panel 10 at a large incident angle to have a small incident angle with respect to the reflective layer 16 of the reflective display panel 10. Since the light 46 incident on the reflective layer 16 at a small incident angle is reflected at a small reflection angle, the light 47 may improve the visibility of the display device 1.

The display device according to the present disclosure may improve the visibility of a display device by a refractive sheet disposed on a front surface of a reflective display panel and including a plurality of prisms.

In addition, the display device according to the present disclosure may improve the visibility of a display device by a refractive sheet disposed on the front surface of a reflective display panel and having a holographic diffraction grating.

In addition, the display device according to the present disclosure may improve the visibility of the display device by the light unit configured to collimate and emit light in front of the display panel toward the refractive sheet.

Although exemplary embodiments have been shown and described, it would be appreciated by those skilled in the art that changes may be made to these exemplary embodiments without departing from the principles and spirit of the present disclosure, the scope of which is defined in the claims and their equivalents.

What is claimed is:

1. A display device comprising:
a reflective display panel;
a light unit configured to emit light to the reflective display panel; and
a refractive sheet disposed on a front surface of the reflective display panel and comprising a plurality of prisms arranged to refract the light emitted from the light unit toward the reflective display panel.

2. The display device of claim 1, wherein each prism of the plurality of the prisms comprises an incident surface to which the light emitted from the light unit is incident, and
wherein the incident surface has an angle that is greater than or equal to 60 degrees and less than or equal to 90 degrees with respect to the front surface of the reflective display panel.

3. The display device of claim 1, wherein the light emitted from the light unit is collimated light.

4. The display device of claim 3, wherein the light emitted from the light unit has an incident angle that is greater than or equal to 60 degrees with respect to the front surface of the reflective display panel.

5. The display device of claim 1, wherein each prism of the plurality of prisms comprises an inclined surface configured to totally reflect the light emitted from the light unit toward the reflective display panel.

6. The display device of claim 1, wherein the plurality of prisms are arranged at an interval from each other so that the light emitted from the light unit is not blocked by a neighboring prism.

7. The display device of claim 1, wherein each prism of the plurality of prisms comprises an exit surface facing the front surface of the reflective display panel, and
wherein the plurality of prisms are arranged at an interval from each other that is larger than a width of the exit surface.

8. The display device of claim 1, wherein the plurality of prisms are continuously arranged without being spaced apart from each other.

9. The display device of claim 1, wherein the light unit comprises:
a light source module comprising a light source configured to emit the light and a substrate on which the light source is arranged;
a parabolic mirror configured to collimate the light to the reflective display panel by reflecting the light emitted from the light source; and
a mounting member configured to mount the light source module and the parabolic mirror on one side of the reflective display panel so that the light source module and the parabolic mirror are disposed in front of the front surface of the reflective display panel.

10. The display device of claim 9, wherein the parabolic mirror extends by a length corresponding to a length of the one side of the reflective display panel on which the parabolic mirror is disposed.

11. The display device of claim 10, wherein the light source module extends by a length corresponding to the length of the parabolic mirror along an extending direction of the parabolic mirror and is arranged to emit the light from a focal line of the parabolic mirror toward the parabolic mirror.

12. A display device comprising:
a reflective display panel;
a light unit configured to emit light to the reflective display panel; and
a refractive sheet disposed on a front surface of the reflective display panel and comprising a holographic diffraction grating configured to refract the light emitted from the light unit toward the reflective display panel.

13. The display device of claim 12, wherein the light unit comprises:
a light source module comprising a light source configured to emit the light and a substrate on which the light source is arranged;
a parabolic mirror configured to collimate the light to the reflective display panel by reflecting the light emitted from the light source; and
a mounting member configured to mount the light source module and the parabolic mirror on one side of the reflective display panel so that the light source module and the parabolic mirror are disposed in front of the front surface of the reflective display panel.

14. A display device comprising:
a liquid crystal layer;
a reflective layer disposed on a rear side of the liquid crystal layer;
a light unit configured to generate collimated light; and
a refractive sheet disposed on a front surface of the liquid crystal layer and configured to refract the collimated light generated by the light unit toward the liquid crystal layer.

15. The display device of claim 14, wherein the refractive sheet comprises a plurality of prisms, and
wherein each prism of the plurality of prisms comprises an incident surface to which the collimated light generated by the light unit is incident and an inclined surface configured to totally reflect light entering through the incident surface.

16. The display device of claim 14, wherein the refractive sheet comprises a holographic diffraction grating configured to refract the collimated light generated by the light unit toward the liquid crystal layer.

17. The display device of claim 14, wherein the light unit comprises:
a light source module comprising a light source configured to emit light and a substrate on which the light source is arranged; and
a parabolic mirror reflecting the light emitted from the light source such that the light emitted from the light source is incident on the refractive sheet at a predetermined angle.
